(19) United States
(12) Patent Application Publication
(10) Pub. No.: US 2007/0266589 A1
(43) Pub. Date: Nov. 22, 2007

(54) Organic Waste Disposal

(76) Inventors: Philip Charles Nicholas, Bridgend (GB); Patrick James Andrews, Swansea (GB)

Correspondence Address: Ronald R Santucci;Frommer Lawrence Haug LLP, 745 Fifth Avenue, New York, NY, 10151, US

(21) Appl. No.: 10/561,728

(22) PCT Filed: Jun. 29, 2004
(86) PCT No.: PCT/GB04/02809

§ 371 Date: Jan. 30, 2007

(30) Foreign Application Priority Data
Jul. 1, 2003 (GB) 0315383.0
Jul. 1, 2003 (GB) 0315384.8
Jul. 1, 2003 (GB) 0315385.5

(51) Int. Cl. F26B 17/20; F26B 1/00; F26B 23/02; F26B 3/22

(52) U.S. Cl. 34/305; 34/180; 34/201; 34/209; 34/282; 34/380; 34/60

(57) ABSTRACT

There is provided a vessel (10) for drying organic waste comprising at least two elongate channels (12), each channel (12) having a length (L) and a substantially segment shaped cross section, with a radius (R) of between 0.25 m and 0.75 m an axle (16) associated with each channel (12), each axle (16) mounted for rotation about an axis parallel to the length (L) of its respective channel (12), each axle (16) mounting a plurality of mixing paddles (18) or one or more helical blades, an interface (22, 24) between the two channels (12) and a first heater for heating the channels (12), wherein, during drying, the axles (16) associated with adjacent channels (12) are arranged to rotate in opposite directions and the interface (22, 24) between adjacent channels (12) is heated.

The present invention relates to organic waste disposal. In particular, the present invention relates to an apparatus and method for organic waste disposal which converts wet organic waste into a powder.

The term “organic waste” is used throughout to mean waste which is predominantly food waste (animal and vegetable waste, cooked or raw) but may include, for example, paper waste and effluent screenings or effluent sludge and may also include a small amount of non-organic packaging (for example foil or plastic). In order for the waste to be classed as organic waste, the proportion of packaging must be low (in general, less than 10% by weight of non renewable materials such as plastics and foils). Other waste, which includes a higher proportion of non-organic waste, is often termed general waste or municipal solid waste (MSW). Organic waste typically has a significantly higher water content than MSW.

MSW may be easily disposed of by burning but organic waste, typically having a water content of more than 40%, can be combusted or gasified more easily after drying. Without drying, such combustion requires high temperatures. This requires the addition of dried material or fuel which reduces the moisture content and allows combustion at a high temperature or gasification. However, a number of methods of disposing of organic waste are known. Such known methods include disposing in landfill sites, as animal feed, by rendering (particularly meat waste and animal by-products), by composting or by digestion (particularly slurries).

However, several such methods of organic waste disposal are becoming less acceptable for a number of reasons. Firstly, there is concern over the environmental impact of waste disposal. It is not known whether landfill sites are having long term detrimental effects on the environment and, as the amount of waste increases, more and more landfill sites are required. There are increased legislation and planning restrictions limiting new sites, particularly those for disposal of food waste. In addition, there is concern over the potential dangers of feeding food waste to livestock.

There is also increasing pressure on industry to take responsibility for their own waste. This means that there are fewer routes available to industry to dispose of their waste safely and that waste disposal is becoming a more and more costly business.

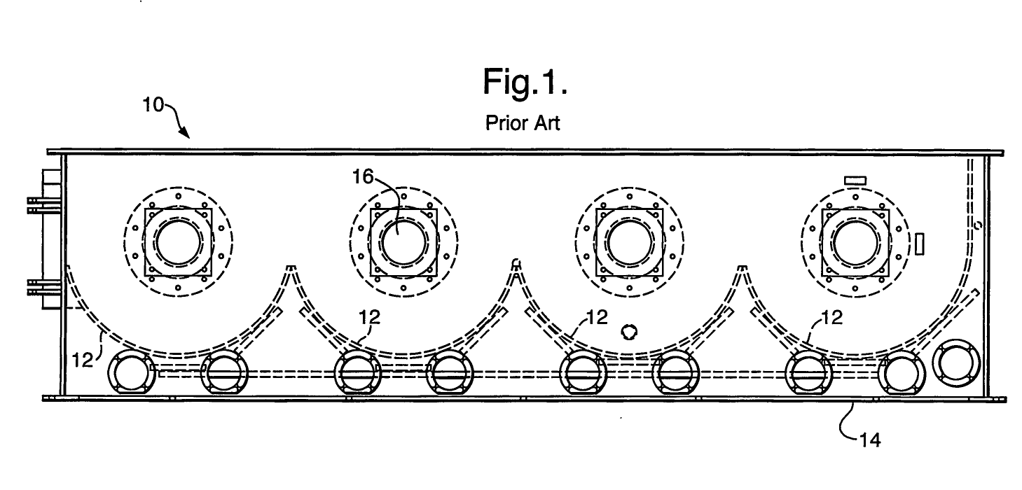

One known system for disposal of organic waste is illustrated in FIG. 1. The organic waste is heated and mixed so that it dries out and is broken down and eventually forms a powder which can be used as a fuel. This system avoids the need for landfill sites as well as avoiding the potential dangers associated with feeding food waste to livestock. However, there are several problems with known organic waste disposal systems which convert wet organic waste to a powder fuel.

The first problem is that, as the organic waste is drying, it forms a thick paste and because this paste is so thick and has only a mid-range water content, the mixers required must be extremely robust. In addition, as the volume of the mixing vessel increases, the forces on the mixers increase so the components are required to be stronger and stronger as the useful capacity of the vessel increases. This increases the cost of components.

Secondly, in order to heat the vessel so as to dry out the organic waste, fuel (generally oil or gas) is required and this must be imported on to the site. The fuel itself, as well as the fuel transport costs, both add to the expense of the disposal.

An object of the present invention is to provide an apparatus and method for processing organic waste which avoids or mitigates the above-mentioned problems with known organic waste processors.

According to a first aspect of the invention, there is provided a vessel for drying organic waste, the vessel comprising at least two elongate channels, each channel having a length and a substantially segment shaped cross section, with a radius of between 0.25 m and 0.75 m.

A radius of between 0.25 and 0.75 m has been found to be extremely advantageous. A radius of less than 0.25 m substantially reduces the capacity of vessel. A radius of more than 0.75 m means that the forces on the mixing paddles, (or one or more helical blades) are large so that the machinery has to be extremely robust and the vessel itself has to be a strong structure. In addition, an increased force on the paddles, as they work against a static bed of material tends to cause compaction of the thick paste into a hard solid which can clog and damage machinery.

In a particularly advantageous embodiment, the radius is between 0.3 m and 0.6 m. In one embodiment, the radius is 0.4 m.

Preferably, the length of each channel is between 3 m and 4 m. With a larger length, the channel can hold a large amount of organic waste. However, as the shaft length increases, the deflection of the shaft will increase and a stiffer shaft must therefore be selected. In a particularly advantageous embodiment, the length of each channel is 3 m.

The vessel may comprise any number of channels greater than one. However, it is particularly preferable for the vessel to comprise four or eight or twelve channels.

According to the first aspect of the invention, there is also provided apparatus for drying organic waste comprising:
a first vessel, as described above, for mixing and heating the organic waste to form an organic paste;
means for adding the organic paste to a first organic powder to form a mixture;
a second vessel, as described above, for mixing and heating the mixture to form a second organic powder; and
means for controlling the rate of addition of the organic paste to the first organic powder, such that the resulting mixture is substantially in powder form.

According to the first aspect of the invention, there is also provided apparatus for drying organic waste comprising:
a vessel, as described above, for mixing and heating a first quantity of organic waste to form an organic powder;
a conversion unit for converting a portion of the organic powder to generate heat for heating a second quantity of organic waste.

Preferably, the conversion unit is a combustion unit for burning the portion of the organic powder.

The apparatus may further comprise a heat exchanger, the heat exchanger using the heat generated by the conversion unit to heat the vessel. Advantageously, the heat exchanger works by circulating hot gas beneath the vessel.

According to the first aspect of the invention, there is also provided a vessel for drying organic waste, the vessel comprising:
at least two elongate adjacent channels, each channel having a length and a substantially segment shaped cross-section;
an axle associated with each channel, each axle mounted for rotation about an axis parallel to the length of its respective channel, each axle mounting a plurality of mixing paddles;
an interface between the two channels; and
a first heater for heating the channels,

wherein, during drying, the axles associated with adjacent channels are arranged to rotate in opposite directions and the interface between adjacent channels is heated so as to enhance breakdown of the organic waste at the interface.

Such an arrangement enhances breakdown of the organic waste, particularly any non-organic packaging within the organic waste. The heated metal interface between two adjacent channels and the action of two counter rotating paddles or blades moving down on this interface and then through the static bed of material creates a “thermal knife” which acts as a shredder for any non-organic packaging.

In one embodiment, the interface is heated by the first heater i.e. the heater which heats the channels also heats the interface. In an alternative embodiment, the interface is heated by a second heater. The second heater may be an electric heater.

In one embodiment, the radius of the cross-section of each channel is between 0.25 m and 0.75 m. In a particularly advantageous embodiment, the radius is between 0.3 m and 0.6 m. In another particularly advantageous embodiment, the radius is 0.4 m.

In one embodiment, the length of each channel is between 3 m and 4 m. In a particularly advantageous embodiment, the length of each channel is 3 m.

The vessel may comprise any number of channels greater than one. However, it is particularly preferable for the vessel to comprise four or eight or twelve channels.

According to the first aspect of the invention, there is also provided apparatus for drying organic waste comprising:
a first vessel, as described above, for mixing and heating the organic waste to form an organic paste;
means for adding the organic paste to a first organic powder to form a mixture;
a second vessel, as described above, for mixing and heating the mixture to form a second organic powder; and
means for controlling the rate of addition of the organic paste to the first organic powder, such that the resulting mixture is substantially in powder form.

According to the first aspect of the invention, there is further provided apparatus for drying organic waste comprising:
a vessel, as described above, for mixing and heating a first quantity of organic waste to form an organic powder;
a conversion unit for converting a portion of the organic powder to generate heat for heating a second quantity of organic waste.

The conversion unit is preferably a combustion unit for burning the portion of the organic powder. The apparatus may further comprise a heat exchanger, the heat exchanger using the heat generated by the conversion unit to heat the vessel. The heat exchanger may operate by circulating hot gas beneath the vessel.

According to a second aspect of the invention, there is provided a method for drying organic waste, comprising the steps of:
mixing and heating the organic waste to form an organic paste; then
adding the organic paste to a first organic powder to form a mixture and mixing and heating the mixture,
wherein the rate of addition of the organic paste to the first organic powder is such that the resulting mixture is substantially in powder form.

The mixing and heating of the mixture may be performed simultaneously with the adding of the organic paste. Alternatively, the mixing and heating may be performed after each addition of organic paste.

By using such a two-stage process, the thick paste phase of the drying process can be substantially avoided. This means that the heating does not have to be so carefully controlled, the machinery does not have to be so robust and the time taken for the entire drying process (from original organic waste to powder bio-fuel) can be reduced. Also, there is a reduced risk that the organic waste will compact and clog machinery. The organic paste is rapidly combined with the first organic paste and the resulting mixture remains substantially in powder form throughout the addition of the organic paste.

The organic waste will typically have a water content of more than about 40% by weight. Of course, it is possible for the organic waste to have a water content of less than about 40% by weight. The water content of the organic waste will depend on the particular composition of the organic waste.

It should be noted that, throughout the specification, the water content percentages or other content percentages (e.g. non-organic packaging) always refer to percentage by weight.

Preferably the organic paste has a water content of between about 20% and about 30% by weight when it is added to the first organic powder. It is possible for the organic paste to have a higher water content. In that case, the rate of addition of the organic paste to the first organic powder will need to be slower in order to maintain the resulting mixture in powder form. For example, the organic paste may have a water content of 40% by weight. Alternatively, it is possible for the organic paste to have a lower water content. In that case, the rate of addition of the organic paste to the first organic powder can be faster. The objective is to reduce the moisture content of the organic paste to as low as possible without the risk of forming a compacted paste. At this point the organic paste is added to the first organic powder at a rate which is appropriate to reduce the risk that the resulting mixture forms an organic paste which may compact. Rather, the resulting mixture remains in powder form.

Preferably, the first organic powder is as dry as possible. As described, this reduces the risk that the mixture will form a paste. Preferably the first organic powder has a water content of less than about 10% by weight. It is possible for the first organic powder to have a higher water content. The exact water content will affect the rate of addition of the organic paste to the first organic powder.

In one embodiment, the method includes the further step of further mixing and heating the mixture to form a second organic powder. Such mixing and heating reduces the water content of the mixture still further, which is appropriate if the resulting second organic powder is to be used as a bio-fuel.

Preferably, the second organic powder has a water content of about 10% by weight. Ultimately, the water content will depend upon the method of conveying the organic powder as a bio-fuel, its storage and its input to energy conversion equipment. It has been found that, with a water content of about 10% by weight, the powder is useful as a bio-fuel since the bio-fuel is physically stable, able to be transported as powder, compressed into briquettes, blown into cyclones and/or screw fed.

The resulting second organic powder can be used as a bio-fuel on site or stored and transported off site. Heat generated from burning can be used in a number of applications. For example, the heat may be used to generate electricity hot water or steam or may be used for refrigeration.

The first organic powder may be formed separately on or off site. However, preferably the method comprises the preliminary step of drying organic waste to form the first organic powder. This preliminary step of drying organic waste to form the first organic powder may be done by mixing and heating the organic waste in either a known one-stage process or a two-stage process according to the invention.

According to the second aspect of the invention, there is also provided apparatus for drying organic waste comprising:
a first vessel for mixing and heating the organic waste to form an organic paste;
means for adding the organic paste to a first organic powder to form a mixture;
a second vessel for mixing and heating the mixture to form a second organic powder; and
means for controlling the rate of addition of the organic paste to the first organic powder, such that the resulting mixture is substantially in powder form.

The first and second vessels may be completely separate vessels or the second vessel may be a separated section of the first vessel.

As described above, the organic waste will typically have a water content of more than about 40% by weight but it is possible for the organic waste to have a water content of less than about 40% by weight.

Preferably the organic paste has a water content of between about 20% and about 30% by weight when it is added to the first organic powder but, as described above, it is possible for the organic paste to have a higher water content or a lower water content. As explained, the exact water content will affect the rate of addition of the organic paste to the first organic powder.

Preferably the first organic powder has a water content of less than about 10% by weight but, as described above, it is possible for the first organic powder to have a higher water content. The exact water content will affect the rate of addition of the organic paste to the first organic powder.

Preferably, the second organic powder has a water content of about 10% by weight. As described previously, it has been found that this percentage water content is advantageous if the second organic powder is to be used as a bio-fuel.

One or both of the first and second vessels may comprise:
at least two elongate channels, each channel having a length and a substantially segment shaped cross-section;
an axle associated with each channel, each axle mounted for rotation about an axis parallel to the length of its respective channel, each axle mounting a plurality of mixing paddles or one or more helical blades; and
a heater for heating the channels.

One or both of the first and second vessels may comprise a vessel according to the first aspect of the invention.

It is intended that any features described above in relation to the method of the second aspect of the invention may also be incorporated into the apparatus of the second aspect of the invention and that any features described above in relation to the apparatus of the second aspect of the invention may also be incorporated into the method of the second aspect of the invention.

According to a third aspect of the invention there is provided a method for drying organic waste, comprising the steps of:
mixing and heating a first quantity of organic waste to form an organic powder;
converting a portion of the organic powder to heat a second quantity of organic waste.

Such a method, where the organic powder itself is used as a fuel to heat the organic waste, has several advantages. The system is self-heating: no fuel needs to be imported on site, which avoids a large expense and a potential hazard. A major proportion of the available energy from the bio-fuel can be usefully used on site in any number of ways. The user can save money on input (by saving the costs which would be incurred to destroy their organic food waste) and can also generate money on output (by using the resulting energy in any of a number of ways). The entire unit can be accommodated on-site, which also reduces the costs of transporting the organic waste.

The organic powder may be converted by conventional combustion in air, or pyrolysis or gasification or by any other suitable conversion process.

The method may be carried out as a step by step process. In that case, in a first step, the first quantity of organic waste is completely broken down to form organic powder. Then, in a second step, a second quantity of organic waste is mixed and heated by using a portion of the organic powder generated in the first step. The remaining organic powder may be exported off site or may be used on site (together with or separately from the selected portion of the organic powder). Then, in a third step, a third quantity of organic waste is mixed and heated by using a portion of the organic powder generated in the second step. Again, the remaining organic powder may be exported off site or may be used on site (together with or separately from the selected portion of the organic powder). And so, the step by step process continues.

Alternatively, the method may be carried out as a continuous process. In that case, as the organic powder is formed, an appropriate portion of it is continuously separated and used to heat more organic waste. The organic powder that is not required to heat the organic waste may be exported off site or may be used on site (together with or separately from the selected portion of the organic powder).

In either a step by step process or a continuous process, the organic powder which is not required to heat the organic waste can be used on site or off site. Heat generated can be used in a number of applications. For example, the heat may be used to generate electricity, hot water or steam or may be used for refrigeration.

The original organic waste will typically have a water content of more than about 40% by weight. Of course, it is possible for the organic waste to have a water content of less than about 40% by weight. The water content of the organic waste will depend on the particular composition of the organic waste.

It should be noted that, throughout the specification, the water content percentages or other content percentages (e.g. non-organic packaging) always refer to percentage by weight.

Preferably, the organic powder has a water content of about 10% by weight. Ultimately, the water content will depend upon the method of conveying the organic powder as a bio-fuel, its storage and its input to energy conversion equipment. It has been found that, with a water content of about 10% by weight, the powder is useful as a bio-fuel since the bio-fuel is physically stable, able to be transported as powder, compressed into briquettes, blown into cyclones and/or screw fed.

The step of mixing and heating the organic waste may be achieved by a known one-stage process. In that case, the organic waste is continuously heated and mixed until it eventually forms an organic powder which can be used as a bio-fuel. It passes through a number of phases: firstly, a high percentage water content phase where the organic waste can be heated extensively since the heat will result in water evaporation; secondly a mousse phase and then a thick paste phase where the mixing machinery must be very robust and the vessel itself must be a strong structure; finally a powder phase with a reduced water content, where the powder can be heated extensively because of its large surface area and ease of mixing. The final result is powder bio-fuel.

Alternatively, the step of mixing and heating the organic waste may be achieved by any other process which converts organic waste into an organic powder by mixing and heating.

According to the third aspect of the invention, there is also provided apparatus for drying organic waste comprising:
a vessel for mixing and heating a first quantity of organic waste to form an organic powder;
a conversion unit for converting a portion of the organic powder to generate heat for heating a second quantity of organic waste.

In one embodiment, the conversion unit may be a combustion unit and the organic powder may be burned. The combustion unit may be a combustion unit of a known type. In other embodiments, the conversion unit is adapted for pyrolysis or gasification.

Preferably, the apparatus further comprises a heat exchanger, the heat exchanger using the heat generated by the conversion unit to heat the vessel. In one embodiment, hot gas generated in the conversion unit is pumped into the heat exchanger.

Preferably, the heat exchanger circulates hot gas beneath the vessel. In some embodiments, the heat exchanger circulates the hot gas through the vessel itself.

The vessel may comprise:
at least two elongate channels, each channel having a length and a substantially segment shaped cross-section; and
an axle associated with each channel, each axle mounted for rotation about an axis parallel to the length of its respective channel, each axle mounting a plurality of mixing paddles or one or more helical blades.

The vessel may comprise a vessel according to the first aspect of the invention.

As described above, the organic waste will typically have a water content of more than about 40% by weight but it is possible for the organic waste to have a water content of less than 40% by weight.

Preferably, the second organic powder has a water content of about 10% by weight. As described previously, it has been found that this percentage water content is advantageous if the second organic powder is to be used as a bio-fuel.

It is intended that any features described above in relation to the method of the third aspect of the invention may also be incorporated into the apparatus of the third aspect of the invention and that any features described above in relation to the apparatus of the third aspect of the invention may also be incorporated into the method of the third aspect of the invention.

It is also intended that any features described above in relation to one aspect of the invention may also be incorporated into another aspect of the invention.

An embodiment of the invention will now be described with reference to the accompanying drawings of which:

FIG. 1 is a cross-sectional view of a known process vessel;

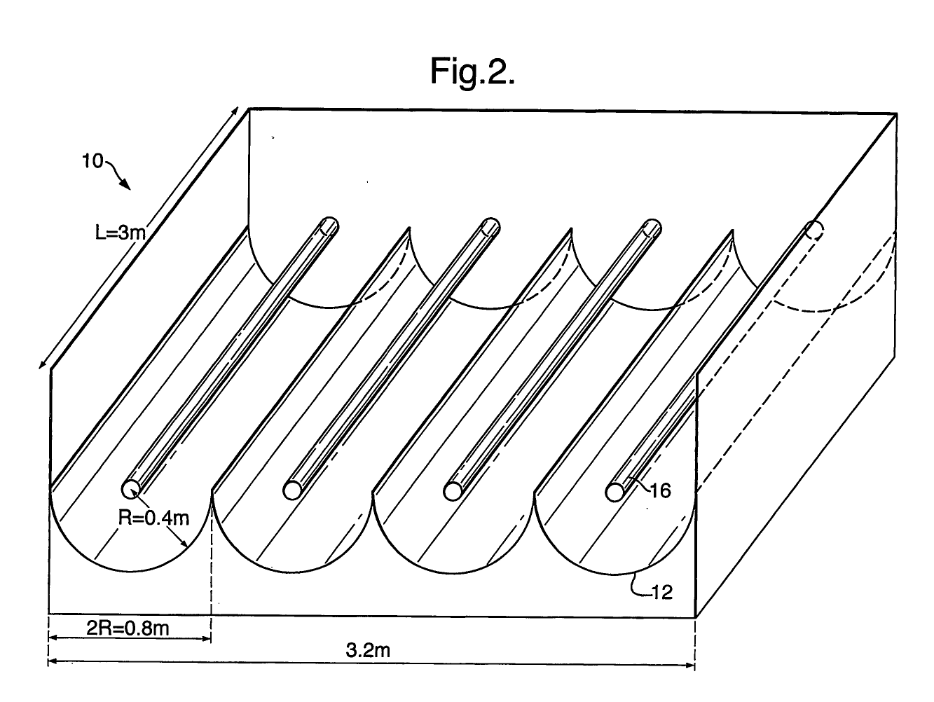

FIG. 2 is a schematic diagram of a process vessel having dimensions according to a first aspect of the invention;

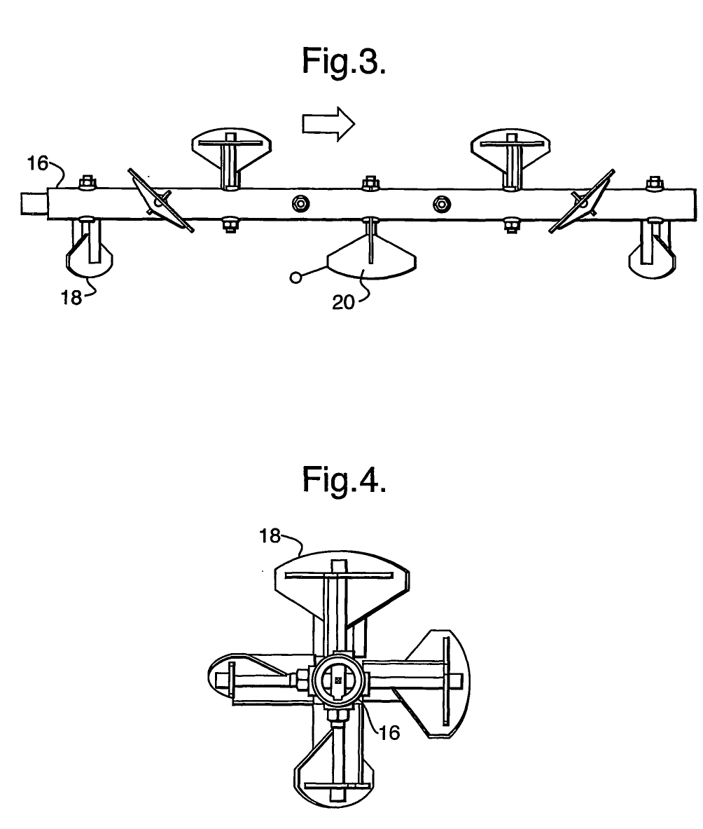

FIG. 3 is a elevational view of an axle, mounting a number of paddles;

FIG. 4 is a cross-sectional view of the axle of FIG. 3;

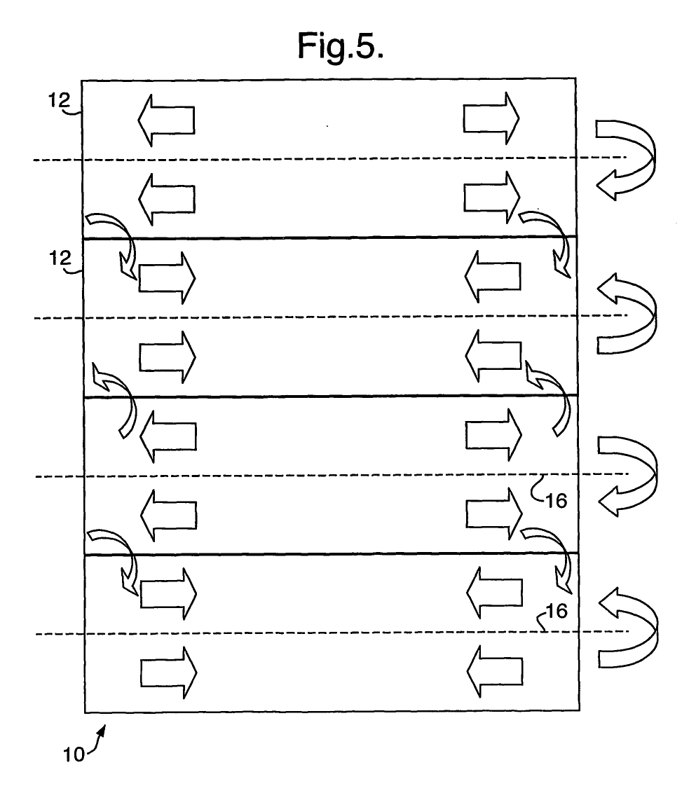

FIG. 5 is a schematic diagram showing circulation of organic waste in a process vessel;

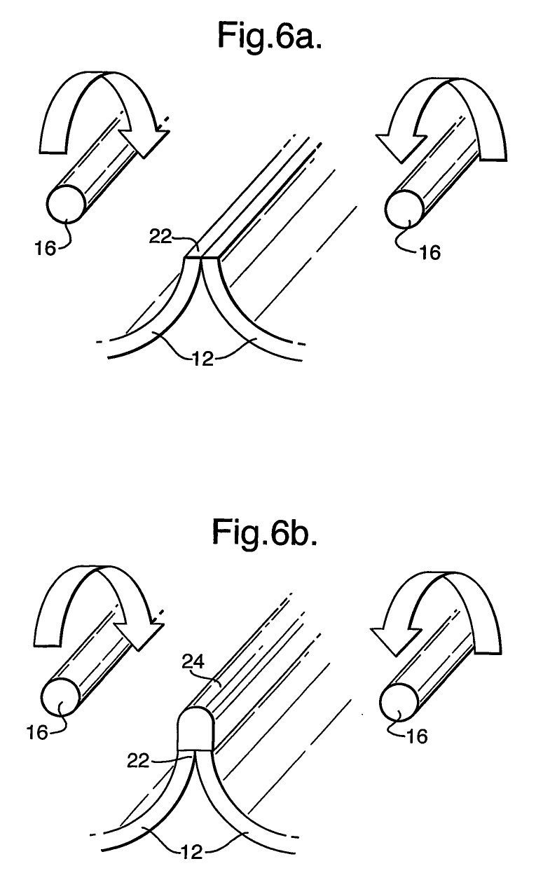

FIG. 6a shows an interface between two channels;

FIG. 6b shows a modified interface between two channels;

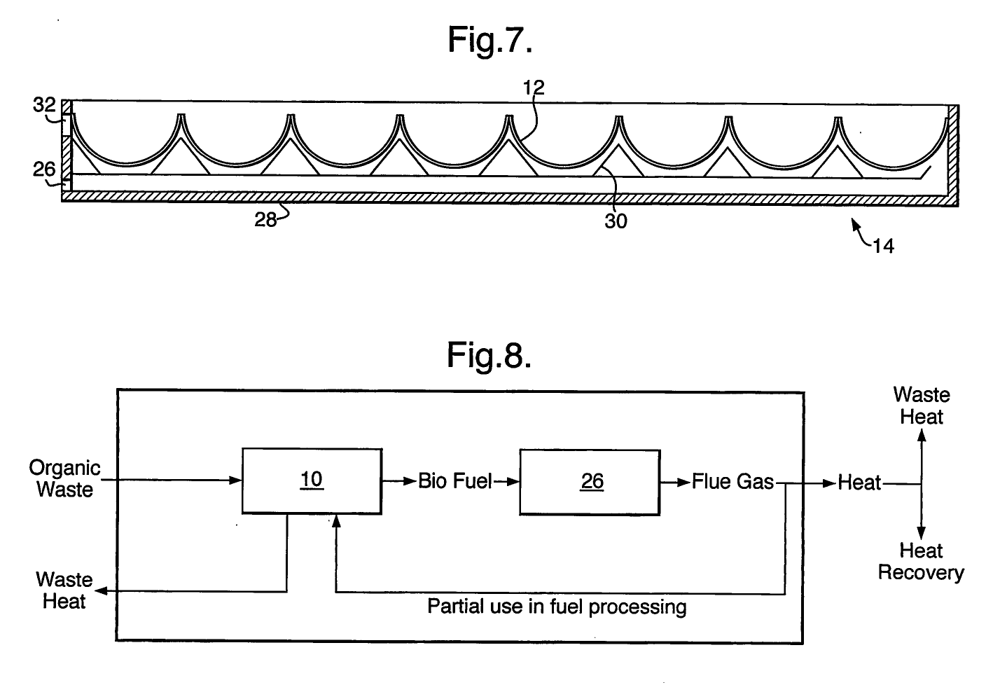

FIG. 7 is a schematic diagram of a heat exchanger; and

FIG. 8 is a schematic diagram showing how the bio-fuel can be used to fuel the heat exchanger.

FIG. 1 shows a known process vessel 10 in cross-section. The vessel comprises four channels 12. Each channel 12 has a cross section which is a segment of a circle. Typically, the arc of the circle, which forms the curved wall of the channel extends about an obtuse angle, typically around 150° of the circle. However, the angle could be 180°, so that the cross section is semi-circular or could be greater than 180° or less than 90° depending on the application. The vessel could comprise fewer or more channels and this will depend on the space available and the amount of organic waste to be processed. Each channel 12 includes an axle 16 which rotates, each axle 16 mounting a number of paddles (not shown) or one or more helical blades (not shown), sometimes known as a ribbon mixer. The channels are heated via a heat exchanger 14, so that the curved portions of each channel reach a high temperature (150° to 250° C. in some applications).

The organic waste is deposited into the channels 12 and, as the paddles or blades rotate and the channel walls heat up, the physical structure of the organic waste is broken down which assists the process of removing water by evaporation. After a certain amount of time, the organic waste is entirely converted to dry organic particles and fibres as well as shreds of the non-organic packaging. The material is then in the form of a powder or sand-like material, which can be used as a fuel. This fuel can be used in a number of applications.

The amount of organic waste which can be processed per unit time will depend, inter alia, on the number of channels, the dimensions of each channel, the type of organic waste, the temperature of each channel and the speed of rotation of the axles.

It has been found that certain dimensions of the process vessel 10 are critical to increase the efficiency of the vessel and ensure it can be easily transported. The first dimension which is important for process vessel efficiency is the radius R of each segment shaped channel 12. If the radius R of each channel 12 is small, obviously, each channel cannot hold much organic waste. Therefore, for the same processing power, the vessel would need to comprise many individual channels together with the associated axles, paddles and motors, making the entire vessel complex and expensive. If the radius R of each channel 12 is large, the paddles and axle 16 must be mechanically very strong, because the torque exerted on each paddle as it rotates through the organic waste will be large. This increases the cost of the machine and its component parts. In addition, with a large channel radius R, the increased force on the paddles acting on an increased mass of static material increases the risk that the organic waste eventually forms a rock-hard deposit, which is difficult, expensive and unpleasant to remove. The optimum channel radius has been found to be in the range 0.25 m to 0.75 m or, even more advantageously, in the range 0.3 m to 0.6 m.

The second dimension which has been found to be important is the length L of each channel. Clearly, for increased volume and hence processing capacity, L should be as large as possible. However, L is limited by the axle strength or stiffness required for each channel axle. The optimum channel length L has been found to be in the range 3 m to 4 m.

FIG. 2 is a schematic diagram of the process vessel 10 showing the dimensions of one embodiment of the vessel according to this aspect of the invention. In this embodiment, each channel can accommodate about one tonne of waste and each axle rotates about once every 15 s at a delivered torque of up to 10000 Nm.

In addition, it has been found that the specific construction of the process vessel components has a great impact on the efficiency of the drying process.

The first aspect of construction which is important to process efficiency is the construction of the paddles mounted on each axle 16. FIGS. 3 and 4 show the axle and paddle construction according to this aspect of the invention. It can be seen that each axle 16 mounts a number of paddles 18. The paddles are mounted at a selection of different angles around the axle 16 (shown clearly in FIG. 4) such that each paddle 18 is moving through the organic waste in the channel 12 at a different time. The paddles 18 are angled such that each paddle surface 20 which contacts the organic waste to move it through the channel 12 is not perpendicular to or parallel to the axle. In fact the paddles 18 are oriented such that, as the axle 16 rotates, the organic waste moves through the channel 12 in a direction parallel to the axle 16.

Adjacent channels 12 have axles mounted to rotate in opposite directions. This means that organic waste moves, for example, from the edges to the centre of the first channel, over the lip into the adjacent second channel, from the centre to the edges of the second channel, over the lip into the adjacent third channel and so on. Thus, the construction and rotation of the axles 16 and paddles 18 ensures that the organic waste circulates through the entire process vessel 10 as shown by schematic diagram FIG. 5. FIG. 5 shows a four-channel process vessel 10 but the circulation system could, of course be applied to any number of channels 12. The efficient circulation means that the process vessel 10 can be used to full capacity, that the active heated surface area of the channels 12 is used as efficiently as possible and that the breakdown of all the organic waste occurs at a consistent speed throughout the volume of the organic waste i.e. it reduces the likelihood that some of the waste is completely broken down, while some remains close to its original un-broken down form.

Another aspect of construction which is important to process efficiency is the construction of the interface between each channel 12. FIG. 6a shows one such interface.

It has been found that, as the paddles 18 of the two adjacent channels 12 counter-rotate, the organic waste is broken down particularly as it is moved over the lip 22 between the two channels 12. The channel surfaces are extremely hot, since they are heated by heat exchanger 14 (not shown in FIG. 6a). The efficient waste breakdown is achieved by a combination of the counter-rotation of the paddles 16 together with the extreme heat at the lip 22 between the two channels 12. This arrangement produces what is termed a “thermal knife” at the interface between the two channels 12. It has been found that any non-organic packaging material within the organic waste is also efficiently broken down by this thermal knife. The non-organic packaging is softened, split and then reduced to shreds which can be easily handled. This means that a process vessel 10 according to this aspect of the invention can be used when the organic waste includes a proportion of packaging. This is advantageous since most waste includes some packaging which might otherwise need to be identified and removed before processing.

FIG. 6b shows a further modification of the interface between the two channels 12. In this embodiment, the interface further includes a separate electric heater 24 on the lip 22. This heater 24 is run by a separate power source (not shown). The heater 24 increases the heat at the interface between the two channels 12 even further, such that the waste breakdown is even more efficient.

As shown previously, the channels 12 are heated from beneath by a heat exchanger 14. A schematic diagram of the heat exchanger of the present invention is shown in FIG. 7, in a process vessel comprising eight channels 12. Hot gas is pumped into the heat exchanger 14 at inlet 26 and into the lower section of the heat exchanger which acts as a pressure balancing chamber to assist in maintaining an even flow of hot air. The hot gas passes over the base of the heat exchanger 14 which is provided with insulation 28 and over the furthest edge of the heating jacket 30. The hot gas then passes over the heating jacket 30 in the upper section adjacent the semi-cylindrical channel surfaces and eventually out of the heat exchanger 14 at outlet 32.

The heat exchanger 14 preferably provides an even heat transfer across the walls of the channels 12 so that there is a substantially uniform temperature distribution throughout the food channels. It has been found that the geometry of the heating jacket 30 has a significant effect on heat transfer. The geometry of the heating jacket 30 also has a significant effect on the velocity of the gas within the heat exchanger 14. By altering the peak heights of the deflection saddles of the heating jacket 30, the velocity and turbulence of the gas can be increased or decreased. Higher gas velocities will generate a turbulent flow field and increase heat transfer by breaking down the boundary layer against the wall of each channel 12 and this means an even heat transfer across the channels 12, whilst the temperature of the hot flue gas falls from the inlet to the outlet of the heat exchanger.

With the heat exchanger design shown in FIG. 7, there is more even heat transfer and the gas inlet temperature may be reduced to within the range 600° C. to 700° C. A lower inlet temperature and even heat transfer allows lower overall operating temperatures, fewer hotspots and less chance of charring of the organic waste.

For a process vessel 10 comprising four food channels 12, having dimensions similar to those shown in FIG. 2, the process vessel can accommodate four tonnes of organic waste.

There now follows two improvements to the method of organic waste disposal already described.

According to another aspect of the invention, it has been found that significant advantage lies in converting the drying process into a two-stage process. In the known one-stage process, as the organic waste is dried to a bio-fuel in the process vessel, it passes through a number of phases. In the first phase, the organic waste has a water content of 40% to 90%. The organic waste can be heated extensively in this phase since the heat will result in water evaporation. The application of physical force and abrasion together with the heat leads to water evaporation and the organic waste is broken down and dried out. The waste becomes a wet liquid/solid mix or a wet paste-like material. In the second phase, the waste is in the form of a thick paste, with a water content of 20% to 30%. Because the paste is thick, the paddles must be very robust in order to move through it and the vessel itself must be a strong structure. In addition, because the paste has a lower water content but is still in paste form, it cannot be too highly heated. The consistency of the paste means that it is difficult for the water to evaporate. Therefore, in order to dry the paste out, the paste must be heated gently so that the paste does not burn. As the water is removed, the thick paste breaks up and in the third phase, the organic waste is in powder form with a water content of less than about 10%. In the third phase, the high surface area of the powder allows the water to evaporate easily and rapidly. The combination of the ease of mixing the powder and the relatively low water content means that the powder can be raised to a high temperature and, just as in the first phase, there is a large amount of evaporation. The final result is powder bio-fuel with a water content of about 10%.

In the second phase, the waste is in the form of a thick paste with a water content of 20% to 30%. The paste takes a long period of time to dry out to the powder form, because water evaporation is relatively difficult. The paste must be heated quite gently over a long period and this stage of the overall process is relatively inefficient. The consistency of the paste also means that the paddles must be reasonably robust.

According to this aspect of the invention, the one-stage drying process is converted to a two-stage drying process, which reduces the problems associated with the thick paste phase of the drying organic waste. In a four-channel process vessel, the vessel can be easily adapted for the two-stage process by separating the second and third channels, so that the four-channel process vessel becomes two two-channel process vessels. This can be achieved by a simple mechanical weir, valve or similar control device. Of course, the process can be carried out in two separate vessels.

In the first and second channels, the organic waste is converted to a paste of about 20% to about 30% water. Once the thick paste phase is reached, the thick paste is added to already formed powder having a water content less than about 10% in the third and fourth channels. The rate of addition is controlled such that the waste in the third and fourth channels remains substantially in powder form. The rate of addition will therefore depend, inter alia, on the type of organic waste, the exact water content of the thick paste and the powder, the temperature of the channels and the rotation speed of the paddles. This method quickly alters the added material to be dried, and allows the powder to be mixed with relatively little power. The two-stage process could, of course, be used in a process vessel with any number of channels.

Thus, in this aspect of the invention, the problematic thick paste phase is avoided. This means that the heating does not have to be so carefully controlled, the machinery does not have to be so robust and the time taken for the entire drying process (from original organic waste to powder bio-fuel) is reduced. Also, there is a reduced risk that the organic waste will compact and clog machinery. The organic paste is rapidly combined with the first organic powder and the resulting mixture remains substantially in powder form throughout the addition of the organic paste.

FIG. 8 shows an embodiment of another aspect of the invention.

FIG. 8 is a schematic diagram showing how the bio-fuel resulting from the drying process can be used for combustion to produce hot flue gas which can be used in the heat exchanger.

Organic waste (typically of 40% to 90% water) is deposited into the process vessel 10 as previously described. The drying process carried out in the process vessel may be the known one-stage process or a two-stage process as described above. The process vessel 10 may consist of between 2 and 12 channels 12. As described, the result of the drying process is a bio-fuel in powder form (typically of 10% water). That bio-fuel is used in a combustion unit of a known type. When the bio-fuel is burned, the resulting hot air (typically 600° C. to 1000° C.) can be used in the heat exchanger 14 of the process vessel 10 to heat the process vessel 10 for the next batch of organic waste being processed. The remaining energy can be exported off-site and can be used in any number of ways, for example to generate electricity, hot water or steam or for refrigeration.

An example of this aspect of the invention follows: 1 tonne of organic waste is deposited into the process vessel. The organic waste is 50% solid waste (500 kg) and 50% water (500 kg). Approximately 900 kW hrs are required to dry the organic waste to a bio-fuel, allowing for some thermal inefficiency, by evaporating approximately 450 kg of water. The resulting 550 kg of bio-fuel comprises approximately 500 kg of solid waste and 50 kg of water i.e. approximately 10% water. The bio-fuel can generate 6 kW hrs per kg of bio-fuel. Thus, the 550 kg of bio-fuel generates 3300 kW hrs of energy. Since 900 kW hrs were required in the heat exchanger to dry the food waste, the resulting energy output per tonne of food waste is 2400 kW.

1. A vessel for drying organic waste, the vessel comprising at least two elongate channels, each channel having a length and a substantially segment shaped cross section, with a radius of between 0.25 m and 0.75 m.

2. A vessel according to claim 1 wherein the radius is between 0.3 m and 0.6 m.

3. A vessel according to claim 2 wherein the radius is 0.4 m.

4. A vessel according to claim 1 wherein the length of each channel is between 3 m and 4 m.

5. A vessel according to claim 4 wherein the length of each channel is 3 m.

6. A vessel according to claim 1 comprising four channels.

7. A vessel according to claim 1 comprising eight channels.

8. A vessel according to claim 1 comprising twelve channels.

9. A vessel as hereinbefore described with reference to FIG. 2.

10. Apparatus for drying organic waste comprising:
a first vessel according to claim 1, for mixing and heating the organic waste to form an organic paste;
means for adding the organic paste to a first organic powder to form a mixture;
a second vessel according to claim 1, for mixing and heating the mixture to form a second organic powder; and
means for controlling the rate of addition of the organic paste to the first organic powder, such that the resulting mixture is substantially in powder form.

11. Apparatus for drying organic waste comprising:
a vessel according to claim 1, for mixing and heating a first quantity of organic waste to form an organic powder;
a conversion unit for converting a portion of the organic powder to generate heat for heating a second quantity of organic waste.

12. Apparatus according to claim 11 wherein the conversion unit is a combustion unit for burning the portion of the organic powder.

13. Apparatus according to claim 11 further comprising a heat exchanger, the heat exchanger using the heat generated by the conversion unit to heat the vessel.

14. Apparatus according to claim 13 wherein the heat exchanger circulates hot gas beneath the vessel.

15. A vessel for drying organic waste, the vessel comprising:
at least two elongate adjacent channels, each channel having a length and a substantially segment shaped cross-section;
an axle associated with each channel, each axle mounted for rotation about an axis parallel to the length of its respective channel, each axle mounting a plurality of mixing paddles or one or more helical blades;
an interface between the two channels; and
a first heater for heating the channels, wherein, during drying, the axles associated with adjacent channels are arranged to rotate in opposite directions and the interface between adjacent channels is heated so as to enhance breakdown of the organic waste at the interface.

16. A vessel according to claim 15 wherein the interface is heated by the first heater.

17. A vessel according to claim 15 wherein the interface is heated by a second heater.

18. A vessel according to claim 15 wherein the radius of the cross-section of each channel is between 25 0.25 m and 0.75 m.

19. A vessel according to claim 18 wherein the radius is between 0.3 m and 0.6 m.

20. A vessel according to claim 19 wherein the radius is 0.4 m.

21. A vessel according to claim 15 wherein the length of each channel is between 3 m and 4 m.

22. A vessel according to claim 21 wherein the length of each channel is 3 m.

23. A vessel according to claim 15 comprising four channels.

24. A vessel according to claim 15 comprising eight channels.

25. A vessel according to claim 15 comprising twelve channels.

26. Apparatus for drying organic waste comprising:
a first vessel according to claim 15, for mixing and heating the organic waste to form an organic paste;
means for adding the organic paste to a first organic powder to form a mixture;
a second vessel according to claim 15 for mixing and heating the mixture to form a second organic powder; and
means for controlling the rate of addition of the organic paste to the first organic powder, such that the resulting mixture is substantially in powder form.

27. Apparatus for drying organic waste comprising:
a vessel according to claim 15, for mixing and heating a first quantity of organic waste to form an organic powder;
a conversion unit for converting a portion of the organic powder to generate heat for heating a second quantity of organic waste.

28. Apparatus according to claim 27 wherein the conversion unit is a combustion unit for burning the portion of the organic powder.

29. Apparatus according to claim 27 further comprising a heat exchanger, the heat exchanger using the heat generated by the conversion unit to heat the vessel.

30. Apparatus according to claim 29 wherein the heat exchanger circulates hot gas beneath the vessel.

31. A method for drying organic waste, comprising the steps of:
mixing and heating the organic waste to form an organic paste; then adding the organic paste to a first organic powder to form a mixture and mixing and heating the mixture,
wherein the rate of addition of the organic paste to the first organic powder is such that the resulting mixture is substantially in powder form.

32. A method according to claim 31 wherein the organic waste has a water content of more than about 40% by weight.

33. A method according to claim 31 wherein the organic paste has a water content of between about 20% and about 30% by weight.

34. A method according to claim 31 wherein the first organic powder has a water content of less than about 10% by weight.

35. A method according to claim 31 further comprising the step of further mixing and heating the mixture to form a second organic powder.

36. A method according to claim 35 wherein the second organic powder has a water content of about 10% by weight.

37. A method according to claim 31 further comprising the preliminary step of drying organic waste to form the first organic powder.

38. A method according to claim 37 wherein the step of drying organic waste to form the first organic powder is done by mixing and heating the organic waste.

39. Apparatus for drying organic waste comprising:
a first vessel for mixing and heating the organic waste to form an organic paste;
means for adding the organic paste to a first organic powder to form a mixture;
a second vessel for mixing and heating the mixture to form a second organic powder; and
means for controlling the rate of addition of the organic paste to the first organic powder, such that the resulting mixture is substantially in powder form.

40. Apparatus according to claim 39 wherein the organic waste has a water content of more than about 40% by weight.

41. Apparatus according to claim 39 wherein the organic paste has a water content of between about 20% and about 30% by weight.

42. Apparatus according to claim 39 wherein the first organic powder has a water content of less than about 10% by weight.

43. Apparatus according to claim 39 wherein the second organic powder has a water content of about 10% by weight.

44. Apparatus according to claim 39 wherein the first vessel comprises:
at least two elongate channels, each channel having a length and a substantially segment shaped cross-section;
an axle associated with each channel, each axle mounted for rotation about an axis parallel to the length of its respective channel, each axle mounting a plurality of mixing paddles or one or more helical blades; and
a heater for heating the channels.

45. Apparatus according to claim 39 wherein the second vessel comprises:
at least two elongate channels, each channel having a length and a substantially segment shaped cross-section;
an axle associated with each channel, each axle mounted for rotation about an axis parallel to the length of its respective channel, each axle mounting a plurality of mixing paddles or one or more helical blades; and
a heater for heating the channels.

46. Apparatus according to claim 39 wherein the first vessel comprises a vessel for drying organic waste, the vessel comprising at least two elongate channels, each channel having a length and a substantially segment shaped cross section, with a radius of between 0.25 m and 0.75 m.

47. Apparatus according to claim 39 wherein the second vessel comprises a vessel for drying organic waste, the vessel comprising at least two elongate channels, each channel having a length and a substantially segment shaped cross section, with a radius of between 0.25 m and 0.75 m.

48. Apparatus for drying organic waste according to the method of claim 31.

49. A method for drying organic waste, comprising the steps of:
mixing and heating a first quantity of organic waste to form an organic powder;
converting a portion of the organic powder to heat a second quantity of organic waste.

50. A method according to claim 49 wherein the step of converting a portion of the organic powder comprises burning a portion of the organic powder.

51. A method according to claim 49 wherein the method is carried out as a step by step process.

52. A method according to claim 49 wherein the method is carried out as a continuous process.

53. A method according to claim 49 wherein the organic waste has a water content of more than about 40% by weight.

54. A method according to claim 49 wherein the organic powder has a water content of about 10% by weight.

55. Apparatus for drying organic waste comprising:
a vessel for mixing and heating a first quantity of organic waste to form an organic powder;
a conversion unit for converting a portion of the organic powder to generate heat for heating a second quantity of organic waste.

56. Apparatus according to claim 55 wherein the conversion unit is a combustion unit for burning the portion of the organic powder.

57. Apparatus according to claim 55 further comprising a heat exchanger, the heat exchanger using the heat generated by the conversion unit to heat the vessel.

58. Apparatus according to claim 57 wherein the heat exchanger circulates hot gas beneath the vessel.

59. Apparatus according to claim 55 wherein the organic waste has a water content of more than 20 about 40% by weight.

60. Apparatus according to claim 55 wherein the organic powder has a water content of about 10% by weight.

61. Apparatus according to claim 55 wherein the vessel comprises:
at least two elongate channels, each channel having a length and a substantially segment shaped cross-section; and
an axle associated with each channel, each axle mounted for rotation about an axis parallel to the length of its respective channel, each axle mounting a plurality of mixing paddles or one or more helical blades.

62. Apparatus according to claim 55 wherein the vessel comprises a vessel for drying organic waste, the vessel comprising at least two elongate channels, each channel having a length and a substantially segment shaped cross section, with a radius of between 0.25 m and 0.75 m.

63. Apparatus for drying organic waste according to the method of claim 31.

64. Apparatus for drying organic waste according to the method of claim 49.
